(19) United States
(12) Patent Application Publication
(10) Pub. No.: US 2018/0307022 A1
(43) Pub. Date: Oct. 25, 2018

(54) OPTICAL OBSERVATION DEVICE

(71) Applicant: Carl Zeiss Meditec AG, Jena (DE)

(72) Inventors: Kai Wicker, Jena (DE); Matthias Wald, Jena (DE); Christoph Hauger, Aalen (DE); Artur Högele, Oberkochen (DE)

(21) Appl. No.: 15/957,476

(22) Filed: Apr. 19, 2018

(30) Foreign Application Priority Data
Apr. 20, 2017 (DE) 10 2017 108 376.6

(51) Int. Cl. G02B 21/02; G02B 21/00; G02B 21/22; G02B 5/20

(52) U.S. Cl. CPC G02B 21/025; G02B 5/205; G02B 21/22; G02B 21/0012

(57) ABSTRACT

An optical observation device having a pupil and at least one adjustable low magnification and one adjustable high magnification is provided, wherein the low magnification is linked to a large pupil diameter (DPmax) and the high magnification is linked to a small pupil diameter (DPmin). A stop apparatus is arranged in a pupil plane or as close as possible to a pupil plane, said stop apparatus having a region diameter which delimits a central transmissive region and having a partly transmissive region that surrounds the central transmissive region outside of the region diameter. The region diameter is smaller than the small pupil diameter (DPmin).

### CROSS REFERENCE TO RELATED APPLICATION

The present application claims priority to German Application No. 10 2017 108 376.6 filed Apr. 20, 2017, the disclosure of which is hereby incorporated by reference herein in its entirety.

### BACKGROUND OF THE INVENTION

### Field of the Invention

The present invention relates to an optical observation device such as a microscope, for example, and, in particular, an operating microscope having a pupil and at least one adjustable low magnification and one adjustable high magnification.

### Description of Related Art

A large aperture for obtaining an image quality that is as high as possible is advantageous when observing an object through a magnifying optical observation device, such as, for instance, a microscope and, in particular, an operating microscope. A large aperture leads to a high light efficiency, and so the observed image does not appear unnecessarily dark, and to a high spatial resolution, and so even very fine details of the observation object are identifiable. Moreover, a large aperture improves the transmission contrast even of rougher details, and so a high image quality is obtained overall.

However, a large aperture also leads to reduced depth of field; i.e., the axial extent over which an observation object is still perceived as sharply resolved is relatively small.

While a lacking depth of field can be compensated by the accommodation of the eye in natural vision, this is only still possible to a restricted extent in the case of high magnifications of a microscope. In the case of digital microscopes, the accommodation option is even dispensed with completely since the optics project the image onto a set focal plane.

If the loss of resolution, brightness and contrast are acceptable, a reduction in the effective aperture by stopping down with the aid of a pinhole aperture is the simplest solution for increasing the depth of field. However, stopping down is problematic in the case of systems with a variable magnification. If the magnification is modified, this also changes the diameter of the pupil of the optical observation device. The pupil diameter is smaller in the case of a high magnification than in the case of a lower magnification.

A stop that in the case of medium and low magnifications and the large pupil diameters linked thereto has a lengthened depth of field as a consequence can be realized by a relatively large diameter of the aperture. However, such a stop has little to no effect on the depth of field in the case of high magnifications since the small pupil in the case of high magnification is trimmed less, or even no longer trimmed at all, by the stop. Conversely, a stop that is optimized for a large depth of field in the case of high magnifications has a very small stop diameter, and so the trim of the larger pupil in medium to low magnifications becomes extreme and consequently very much light, resolution and contrast are lost. Although the depth of field would be increased many times at these medium to low magnifications, the applicative use of such a greatly increased depth of field is rather low.

### SUMMARY OF THE INVENTION

It is an object of the present invention to provide an optical observation device in which the depth of field can be increased at high magnifications, wherein, however, light, resolution and contrast are not lost excessively at medium to low magnifications.

The aforementioned object is achieved by an optical observation device as claimed in claim 1. The dependent claims contain advantageous embodiments of the invention.

An optical observation device according to the invention facilitates setting of at least one low magnification and at least one high magnification, wherein the low magnification is linked to a large pupil diameter and the high magnification is linked to a small pupil diameter. According to the invention, the optical observation device is equipped with a stop apparatus that is arranged in a pupil plane or as close as possible to a pupil plane and that has a central transmissive region having a region diameter. Outside of the central region, the stop apparatus has a partly transmissive region which surrounds the central region outside of the region diameter. Here, the region diameter is smaller than the small pupil diameter.

The stop apparatus leads to the largest part of the intensity of the imaging in the case of a small pupil originating from the central transmissive region, which consequently primarily sets the aperture. By contrast, the remaining part of the beam belonging to the small pupil is largely blocked by the partly transmissive region. As a result of this central transmissive region having a diameter that is smaller than the pupil diameter, it is possible to increase the depth of field in the case of high magnifications, i.e. small pupil diameters. By contrast, in the case of low magnifications and the large pupils linked therewith, a significant portion of the beam is transmitted through the partly transmissive region, and so the portion of the beam transmitted through the central transmissive region is relatively low in comparison with the entire transmitted beam. What this can achieve is that a high resolution, a high image brightness and a high contrast are maintained in the case of large pupils.

In a first configuration of the optical observation device according to the invention, the stop apparatus is formed by a ring stop, said ring stop having an outer diameter that delimits the stop radially to the outside and an inner diameter that delimits the stop radially to the inside and surrounds a central stop region. Here, the inner diameter is smaller than the small pupil diameter and the central stop region forms the central transmissive region with the inner diameter as region diameter. The outer diameter of the ring stop is at least as large as the small pupil diameter and smaller than the large pupil diameter such that the region of the ring stop situated outside of the inner diameter is geometrically partly transmissive for pupils with a pupil diameter that is greater than the outer diameter. All pupils with diameters that are smaller than the outer diameter of the ring stop are trimmed to the diameter of the central region in this embodiment variant. In this configuration, the region of the ring stop situated outside of the inner diameter forms the partly transmissive region of the stop apparatus. The partial transmissivity of this region is given in this embodiment variant by virtue of the fact that, from a pupil diameter that is greater than the outer diameter of the stop, one part of the part of the beam belonging to the pupil that is incident on the stop outside of the inner diameter is blocked by the ring stop whereas another part passes the stop outside of the outer diameter. Thus, although pupils that are larger than the outer diameter of the ring stop are also trimmed, there is an annular outer region of the beam that remains untrimmed. Thus, above a certain pupil diameter, the aperture of the beam continues to be set by the full pupil diameter. Although the obstruction by the ring stop reduces the contrast and light intensity of the imaging in relation to an unobstructed pupil, this is pronounced less strongly than if the pupil were restricted exclusively to the central region of the imaging apparatus. The resolving power is essentially not reduced at all by the obstruction.

Ideally, the stop is arranged in a pupil plane of the optical observation device. However, in real systems, there often is no access to a pupil plane since this virtual plane may, in part, lie between, or even in, optical elements such as lenses. In this case, the stop is attempted to be placed as close as possible to a pupil plane. However, if the stop lies even only slightly outside of the pupil plane, this leads to the exact pupil position in a plane perpendicular to the optical axis of the optical observation device depending on the position of the point in the object field from which a beam originates. This displacement of the pupil position depending on the position of the point in the object field increases with increasing distance of the stop from the pupil plane. If the ring stop in the optical observation device according to the invention is arranged outside of a pupil plane, wherein, then, the lateral pupil position for a point in the object field with a field radius depends on the position of the point within the field radius, the outer diameter of the ring stop is selected in such a way that, for pupil diameters that are smaller than a certain limit diameter, i.e. for magnifications that are higher than a limit magnification, the outer edge of the pupil does not project beyond the outer diameter of the ring stop for each position of an object point within 50% of the field radius, in particular within 75% of the field radius. The outer edge of the pupil projecting beyond the outer diameter of the ring stop for certain positions of object field points in the object field leads to the light transmitted by the region outside of the outer diameter being perceived as a bright ring in the image, which may be bothersome. The creation of such a ring in the case of magnifications beyond the limit magnification can be avoided by the above-described configuration. At low magnifications, it is possible at least to reduce the intensity of the ring.

If the pupil diameter is greater than the outer diameter of the ring stop, the rays of the beam transmitted outside of the ring stop can interfere with the rays of the beam transmitted within the ring stop. This interference reduces the image contrast since it displaces light from the central Airy disk into the diffraction rings. However, the interference can be prevented if there is a difference that is greater than the coherence length of the light between the optical path lengths of the light rays transmitted through the central stop region and the light rays transmitted outside of the outer diameter. Therefore, in one development of the ring stop, the central stop region is filled with an optical element that increases the optical path length of the rays of a beam passing therethrough in such a way that the optical path length difference between a beam that passes through the central stop region and a beam that passes the ring stop outside of the diameter thereof is greater than the coherence length of the employed light. In an alternative variant of this development, an optical element adjoins the outer circumference of the ring stop, said optical element increasing the optical path length of the rays of a beam passing therethrough in such a way that the optical path length difference between a beam that passes through the central stop region and a beam that passes the ring stop outside of the diameter thereof is greater than the coherence length of the employed light. Consequently, it is possible to counteract interference effects using these two embodiment variants, and so the image contrast is increased. Moreover, the diffraction effects would also lead to a reduction in the depth of field. This reduction in the depth of field can also be avoided by using an optical element that is arranged in the central stop region of the ring stop or an optical element that adjoins the outer circumference of the ring stop.

In a second embodiment variant of the optical observation device according to the invention, the stop apparatus is formed by a filter with a central transmissive filter region and a partly transmissive filter region that surrounds the central transmissive filter region. The boundary between the central transmissive filter region and the partly transmissive filter region defines the region diameter of the stop apparatus in this embodiment variant. The central filter region forms the central transmissive region of the stop apparatus and the partly transmissive filter region forms the partly transmissive region of the stop apparatus. In this embodiment variant, the pupil is not restricted exclusively to the central transmissive region. Instead, only the intensity of the light is reduced outside of the central transmissive region. By way of example, this can be achieved by virtue of the partly transmissive filter region being embodied as a neutral-density filter. Alternatively, it is also possible to embody the partly transmissive region as a sieve aperture or as a partly reflective region. The configuration of the stop apparatus as a filter with a central transmissive filter region and a partly transmissive filter region surrounding the central transmissive filter region has the effect in the case of small pupils that the majority of the transmitted light is transmitted without attenuation via the central filter region. Only a small part is transmitted via the partly transmissive region of the filter. In this case, the depth of field is substantially set by the higher intensity of the component transmitted through the central transmissive filter region, and so a high depth of field can be obtained. In the case of low magnifications and the large pupils linked therewith, by contrast, the pupil area apportioned to the central filter region is relatively small in comparison with the pupil area apportioned to the partly transmissive filter region, and so the central filter region makes a relatively small contribution to imaging. The imaging is therefore largely dominated by the complete pupil, and so there is no increase in the depth of field but the high resolution and the contrast of the large pupil are maintained. For the effectiveness of this type of stop apparatus, it is advantageous if the transmissive filter region has a transmission in the range from 10% to 30%, in particular in the range from 15% to 25%. However, it is also possible to design the transmission of the partly transmissive filter region to be adjustable.

In a third embodiment variant, the stop apparatus represents a combination of the two variants described above. In this variant, the stop apparatus is formed by a ring stop which has an inner diameter that delimits the stop radially to the inside and surrounds a central stop region. In this case, however, the inner diameter is greater than the small pupil diameter and smaller than the large pupil diameter. A filter with a central transmissive filter region and a partly transmissive filter region surrounding the central transmissive filter region is present in the central stop region delimited by the inner diameter. Here, the central filter region forms the central transmissive region of the stop apparatus. The partly transmissive filter region, together with the region of the ring stop lying outside of the inner diameter, forms the partly transmissive region of the stop apparatus. This configuration facilitates an adaptation of the effect of the stop apparatus in view of the depth of field and the brightness to specific requirements by adapting the inner diameter of the ring stop and the diameter of the central transmissive filter region. By way of a suitable selection of the two aforementioned parameters, it is possible to obtain an ideal compromise between depth of field and brightness.

The ring stop and/or the filter can be affixed to a holder by means of braces, said holder fastening said ring stop and/or filter in the beam path of the optical observation device. Alternatively, there is the option of applying the ring stop and/or the filter onto a transmissive substrate that is placed into the beam path. Here, the application on a transmissive substrate is advantageous in that no braces, which would in turn cause diffraction effects, are necessary.

In the optical observation device according to the invention, the partly transmissive region of the stop apparatus may be partly transmissive for only a certain wavelength range and completely transmissive for another wavelength range. As a result, it is possible to restrict the effect of the stop apparatus to certain wavelength ranges. Thus, it is possible, for example, to develop a stop apparatus that is effective in the visible wavelength range but passes weak fluorescence light unimpeded so as not to impair the brightness of the fluorescence light.

In the optical observation device according to the invention, the stop apparatus can be fastened to a holder, in particular, by means of which it can be pivoted or inserted into the beam path of the optical observation device. Then, the stop apparatus is only pivoted or inserted into the beam path if a high depth of field should be obtained in the case of high magnifications. In other cases, the stop apparatus can be pivoted or pulled out of the beam path in order to keep the resolution, the image brightness and the image contrast as high as possible.

Further features, properties and advantages of the present invention will become apparent from the following description of exemplary embodiments with reference to the accompanying figures.

### BRIEF DESCRIPTION OF THE DRAWINGS

FIG. 1 schematically shows the construction of an operating microscope with an optical view.

FIG. 2 shows a varioscope objective.

FIG. 3 shows an operating microscope with a purely electronic view.

FIG. 4 shows a stop apparatus in the form of a ring stop.

FIG. 5 shows the ring stop of FIG. 4 in a beam path.

FIG. 6 shows, for a ring stop of FIG. 4 which is not arranged exactly in a pupil plane, the effect thereof on an object field point on the optical axis.

FIG. 7 shows the effect of the stop not arranged exactly in a pupil plane on an object field point at a mid-range distance from the optical axis.

FIG. 8 shows the effect of the stop only arranged in the vicinity of the image plane on an object field point at the edge of the object field.

FIG. 9 shows an embodiment variant of the stop of FIG. 4, in which the stop is surrounded by a transmissive optical element for lengthening the path in glass.

FIG. 10 shows the stop of FIG. 9 in a beam path.

FIG. 11 shows a neutral-density filter with a central completely transmissive region.

FIG. 12 shows the neutral-density filter of FIG. 11 in a beam path.

FIG. 13 shows a ring stop, in the aperture of which there is arranged a neutral-density filter with a central completely transmissive region.

FIG. 14 shows the stop of FIG. 13 in a beam path.

FIG. 15 shows a ring stop that is applied to a carrier.

FIG. 16 shows a ring stop that is held by a frame.

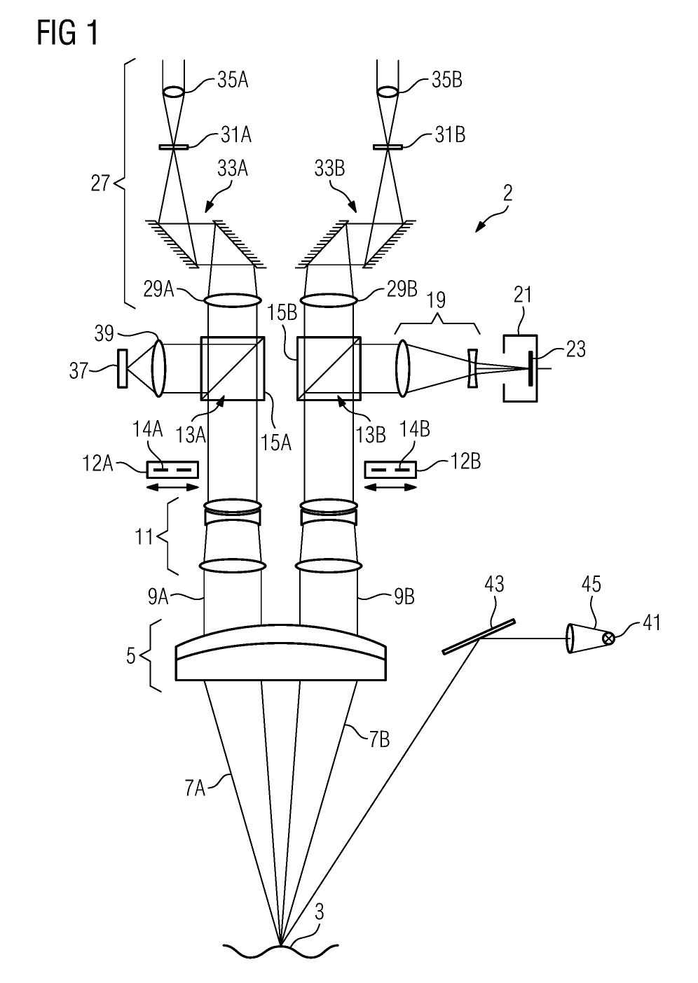

The basic structure of the operating microscope 2 is explained below with reference to FIG. 1.

### DETAILED DESCRIPTION OF THE INVENTION

The operating microscope 2 shown in FIG. 1 comprises an objective 5 that should face an object field 3, said objective, in particular, being able to be embodied as an achromatic or apochromatic objective. In the present exemplary embodiment, the objective 5 consists of two partial lenses that are cemented to one another and form an achromatic objective. The object field 3 is arranged in the focal plane of the objective 5 such that it is imaged at infinity by the objective 5. Expressed differently, a divergent beam 7 emanating from the object field 3 is converted into a parallel beam 9 during its passage through the objective 5.

A magnification changer 11 is arranged on the observer side of the objective 5, which magnification changer can be embodied either as a zoom system for changing the magnification factor in a continuously variable manner as in the illustrated exemplary embodiment, or as a so-called Galilean changer for changing the magnification factor in a stepwise manner. In a zoom system, constructed by way of example from a lens combination having three lenses, the two object-side lenses can be displaced in order to vary the magnification factor. In actual fact, however, the zoom system also can have more than three lenses, for example four or more lenses, in which case the outer lenses then can also be arranged in a fixed manner. In a Galilean changer, by contrast, there are a plurality of fixed lens combinations which represent different magnification factors and which can be introduced into the beam path alternately. Both a zoom system and a Galilean changer convert an object-side parallel beam into an observer-side parallel beam having a different beam diameter. In the present exemplary embodiment, the magnification changer 11 already is part of the binocular beam path of the operating microscope 1, i.e. it has a dedicated lens combination for each stereoscopic partial beam path 9A, 9B of the operating microscope 1. In the present exemplary embodiment, a magnification factor is adjusted by means of the magnification changer 11 by way of a motor-driven actuator which, together with the magnification changer 11, is part of a magnification changing unit for adjusting the magnification factor.

In the present example, the magnification changer 11 is adjoined on the observer side by an interface arrangement 13A, 13B, by means of which external devices can be connected to the operating microscope 1 and which comprises beam splitter prisms 15A, 15B in the present exemplary embodiment. However, in principle, use can also be made of other types of beam splitters, for example partly transmissive mirrors. In the present exemplary embodiment, the interfaces 13A, 13B serve to output couple a beam from the beam path of the operating microscope 2 (beam splitter prism 15B) and to input couple a beam into the beam path of the operating microscope 2 (beam splitter prism 15A).

In the present exemplary embodiment, the beam splitter prism 15A in the partial beam path 9A serves to mirror information or data for an observer into the partial beam path 9A of the operating microscope 1 with the aid of a display 37, for example a digital mirror device (DMD) or an LCD display, and an associated optical unit 39 by means of the beam splitter prism 15A. A camera adapter 19 with a camera 21 fastened thereto, said camera being equipped with an electronic image sensor 23, for example with a CCD sensor or a CMOS sensor, is arranged at the interface 13B in the other partial beam path 9B. By means of the camera 21, it is possible to record an electronic image and, in particular, a digital image of the tissue region 3. In particular, a hyperspectral sensor also can find use as an image sensor, said hyperspectral sensor having not only three spectral channels (e.g. red, green and blue) but a multiplicity of spectral channels.

Between the magnification changer 11 and the interface arrangement 13A, 13B, there are two stop apparatuses 14A, 14B, in each case one for the first binocular partial beam path 9A and the second binocular partial beam path 9B. If necessary, the stop apparatuses 14A, 14B can be introduced into the respectively assigned binocular partial beam path 9A, 9B by means of a suitable displacement apparatus 12A, 12B, which is only indicated very schematically in the figure. The function and the effect of the stop apparatuses 14A, 14B are described below. By way of example, the displacement apparatus 12A, 12B can be embodied as a pivoting apparatus, with the aid of which the stop apparatuses 14A, 14B can be pivoted into the respective binocular partial beam path 9A, 9B. However, it can also be embodied as a pushing apparatus, with the aid of which the stop apparatuses 14A, 14B can be inserted into the respective binocular partial beam path 9A, 9B.

In the present example, a binocular tube 27 adjoins the interface arrangement 13A, 13B on the observer side. It has two tube objectives 29A, 29B, which focus the respective parallel beam 9A, 9B onto an intermediate image plane 31, i.e. image the observation object 3 onto the respective intermediate image plane 31A, 31B. The intermediate images situated in the intermediate image planes 31A, 31B are finally imaged at infinity in turn by eyepiece lenses 35A, 35B, such that an observer can observe the intermediate image with a relaxed eye. Moreover, an increase in the distance between the two partial beams 9A, 9B is effectuated in the binocular tube by means of a mirror system or by means of prisms 33A, 33B in order to adapt said distance to the intraocular distance of the observer. In addition, image erection is carried out by the mirror system or the prisms 33A, 33B.

The operating microscope 2 moreover is equipped with an illumination apparatus, by means of which the object field 3 can be illuminated with broadband illumination light. To this end, the illumination apparatus has a white-light source 41, for example a halogen lamp or a gas discharge lamp, in the present example. The light emanating from the white-light source 41 is directed in the direction of the object field 3 via a deflection mirror 43 or a deflection prism in order to illuminate said field. Furthermore, an illumination optical unit 45 is present in the illumination apparatus, said illumination optical unit ensuring uniform illumination of the entire observed object field 3.

Reference is made to the fact that the illumination beam path illustrated in FIG. 1 is very schematic and does not necessarily reproduce the actual course of the illumination beam path. In principle, the illumination beam path can be embodied as a so-called oblique illumination, which comes closest to the schematic illustration in FIG. 1. In such oblique illumination, the beam path extends at a relatively large angle (6° or more) with respect to the optical axis of the objective 5 and, as illustrated in FIG. 1, may extend completely outside the objective. Alternatively, however, there is also the possibility of allowing the illumination beam path of the oblique illumination to extend through a marginal region of the objective 5. A further option for the arrangement of the illumination beam path is the so-called 0° illumination, in which the illumination beam path extends through the objective 5 and is input coupled into the objective between the two partial beam paths 9A, 9B, along the optical axis of the objective 5 in the direction of the object field 3. Finally, it is also possible to embody the illumination beam path as a so-called coaxial illumination, in which a first illumination partial beam path and a second illumination partial beam path are present. The illumination partial beam paths are input coupled into the operating microscope in a manner parallel to the optical axes of the observation partial beam paths 9A, 9B by way of one or more beam splitters such that the illumination extends coaxially in relation to the two observation partial beam paths.

In the embodiment variant of the operating microscope 2 shown in FIG. 1, the objective 5 only consists of an achromatic lens with a fixed focal length. However, use can also be made of an objective lens system made of a plurality of lenses, in particular a so-called varioscope objective, by means of which it is possible to vary the working distance of the operating microscope 2, i.e. the distance between the object-side focal plane and the vertex of the first object-side lens surface of the objective 5, also referred to as front focal distance. The object field 3 arranged in the focal plane is imaged at infinity by the varioscope objective 50, too, and so a parallel beam is present on the observer side.

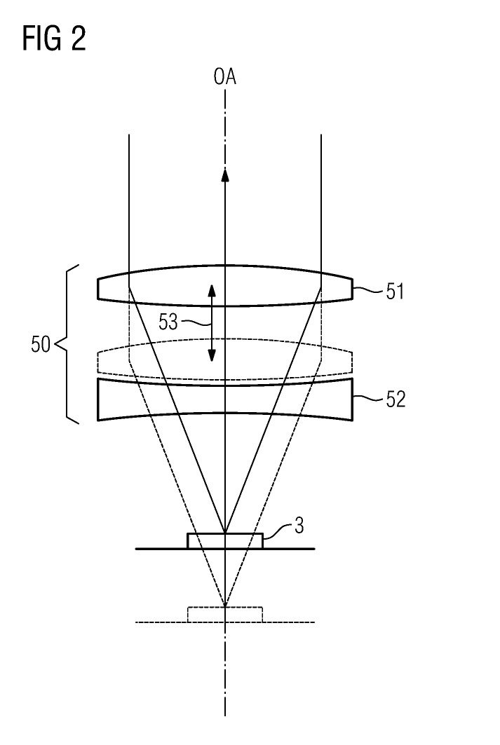

One example of a varioscope objective is illustrated schematically in FIG. 2. The varioscope objective 50 comprises a positive member 51, i.e. an optical element having positive refractive power, which is schematically illustrated as a convex lens in FIG. 2. Moreover, the varioscope objective 50 comprises a negative member 52, i.e. an optical element having negative refractive power, which is schematically illustrated as a concave lens in FIG. 2. The negative member 52 is situated between the positive member 51 and the object field 3. In the illustrated varioscope objective 50, the negative member 52 has a fixed arrangement, whereas, as indicated by the double-headed arrow 53, the positive member 51 is arranged to be displaceable along the optical axis OA. When the positive member 51 is displaced into the position illustrated by dashed lines in FIG. 2, the back focal length increases, and so there is a change in the working distance of the operating microscope 2 from the object field 3.

Even though the positive member 51 has a displaceable configuration in FIG. 2, it is also possible, in principle, to arrange the negative member 52 to be movable along the optical axis OA instead of the positive member 51. However, the negative member 52 often forms the last lens of the varioscope objective 50. A stationary negative member 52 therefore offers the advantage of making it easier to seal the interior of the operating microscope 2 from external influences. Furthermore, it is noted that, even though the positive member 51 and the negative member 52 in FIG. 2 are only illustrated as individual lenses, each of these members may also be realized in the form of a lens group or a cemented element instead of in the form of an individual lens, e.g. in order to embody the varioscope objective to be achromatic or apochromatic.

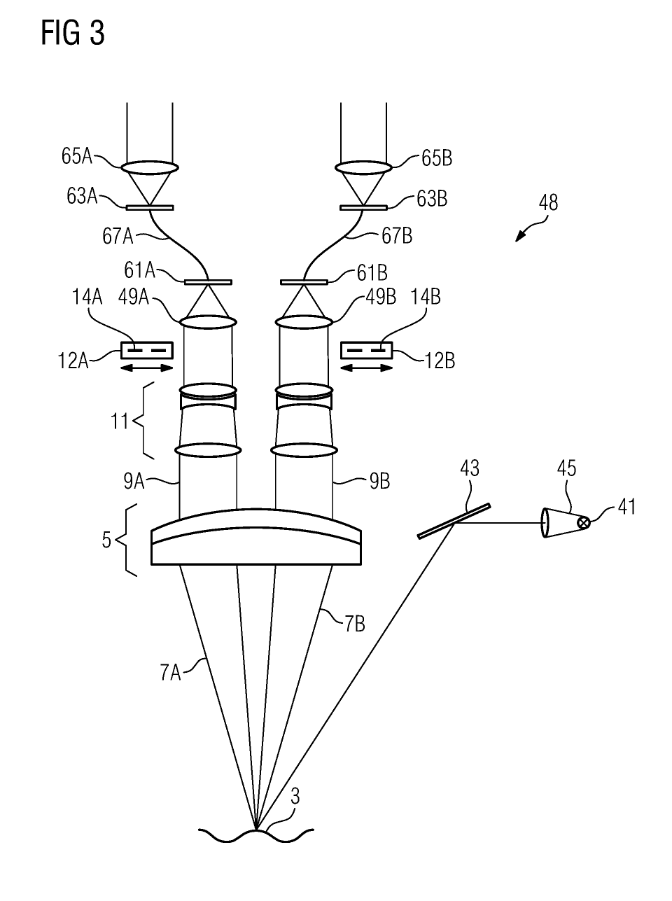

FIG. 3 shows a schematic illustration of an example of a digital operating microscope 48. In this operating microscope, the main objective 5, the magnification changer 11 and the illumination system 41, 43, 45 do not differ from the operating microscope 2 with the optical view that is illustrated in FIG. 1. The difference lies in the fact that the operating microscope 48 shown in FIG. 3 does not comprise an optical binocular tube. Instead of the tube objectives 29A, 29B from FIG. 1, the operating microscope 48 from FIG. 3 comprises focusing lenses 49A, 49B, by means of which the binocular observation beam paths 9A, 9B are imaged onto digital image sensors 61A, 61B. Here, the digital image sensors 61A, 61B can be e.g. CCD sensors or CMOS sensors. The images recorded by the image sensors 61A, 61B are transmitted digitally to digital displays 63A, 63B, which may be embodied as LED displays, as LCD displays or as displays based on organic light-emitting diodes (OLEDs). Like in the present example, eyepiece lenses 65A, 65B can be assigned to the displays 63A, 63B, by means of which the images displayed on the displays 63A, 63B are imaged at infinity such that an observer can observe said images with relaxed eyes. The displays 63A, 63B and the eyepiece lenses 65A, 65B can be part of a digital binocular tube; however, they can also be part of a head-mounted display (HMD) such as e.g. a pair of smartglasses.

Even though FIG. 3, like FIG. 1, only illustrates an achromatic lens 5 with a fixed focal length, the operating microscope 48 shown in FIG. 3 may comprise a varioscope objective instead of the objective lens 5, like the operating microscope 2 illustrated in FIG. 1. Furthermore, FIG. 3 shows a transfer of the images recorded by the image sensors 61A, 61B to the displays 63A, 63B by means of cables 67A, 67B. However, instead of in a wired manner, the images can also be transferred wirelessly to the displays 63A, 63B, especially if the displays 63A, 63B are part of a head-mounted display.

The microscope 2, 48, whether with an optical view or a digital view, renders it possible to set different magnifications between a minimum magnification and a maximum magnification with the aid of the magnification changer 11. Using the zoom system illustrated in FIGS. 1 and 3, it is possible to set the magnification continuously, for example. Here, low magnifications are accompanied by a large device pupil and high magnifications are accompanied by a small device pupil. If the magnification is increased, the device pupil is reduced, and vice versa.

The device pupil decisively influences the optical properties of the microscope. In particular, the diameter of the device pupil influences the image brightness, with a larger pupil leading to a brighter image than a small pupil on account of the greater light throughput through the microscope. Moreover, the device pupil also determines the spatial resolution of the microscope which primarily depends on the numerical aperture, the latter including the size of the device pupil. A larger device pupil increases the numerical aperture and consequently increases the resolving power of the microscope. Furthermore, a large device pupil in comparison with a small device pupil also leads to better contrast transmission, and so a higher-contrast image arises in the case of a larger pupil than in the case of a smaller pupil.

However, the depth of field of the microscope also depends on the diameter of the pupil. In the case of a large pupil, i.e. a high numerical aperture, the aperture cone of a beam emanating from an object point is more obtuse than in the case of a small device pupil, i.e. a small numerical aperture. The obtuse aperture cone leads to the light originating from an object region that is larger than the resolving power of the microscope already in the case of a slight displacement of the focal plane. The image becomes unsharp once this limit has been reached. In the case of a smaller pupil and the smaller aperture angle of the beam accompanying this at the same focal distance, the focal plane can be displaced further without the object region from which light reaches the beam being greater than the resolution limit of the microscope. A microscope with a smaller pupil, i.e. smaller aperture, is consequently more focus-tolerant than a microscope with a large pupil, i.e. large aperture, if the microscope has the same focal length in both cases. Thus, a large pupil diameter leads to a reduced depth of field; i.e., the axial extent over which a sample is still perceived as sharply resolved is reduced.

In principle, it is possible to increase the depth of field using a pinhole aperture. If this should be effective at high magnifications, however, the diameter of the aperture must be smaller than the pupil diameter at the high magnification. This leads to relatively small aperture diameters of the pinhole apertures, which in turn leads to high light losses in the case of a large pupil diameter.

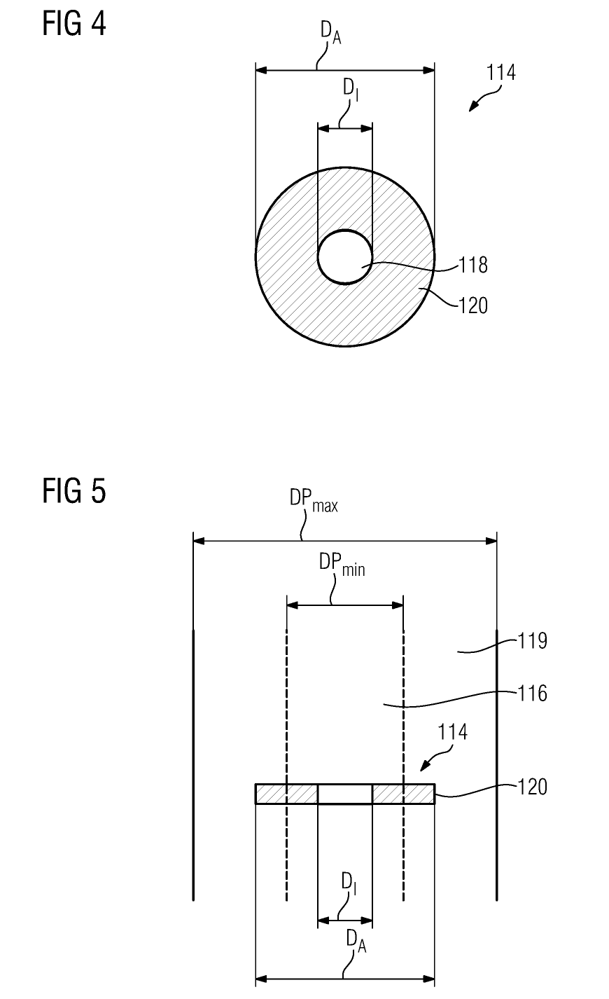

Therefore, according to the invention, a stop apparatus is proposed, said stop apparatus allowing the depth of field to be improved at high magnifications and, at the same time, keeping the loss of brightness afflicted by the stop apparatus 14A, 14B small in the case of low magnifications (large device pupils). According to a first exemplary embodiment, this is brought about by a ring-shaped stop 114, referred to as ring stop 114 below, as illustrated in a plan view in FIG. 4. FIG. 5 shows the ring stop 114 in a cut side view together with a beam 116, as is present in the case of the maximum magnification, and a beam 118, as is present in the case of the minimum magnification of the microscope. The ring stop 114 has a central aperture with an aperture diameter that forms the inner diameter DI of the ring stop 114. The stop diameter itself corresponds to the outer diameter DA of the ring stop 114. The aperture 118 is surrounded by an opaque stop region 120, which blocks the transmission of a beam. However, instead of being opaque, the stop region 120 may also have a reflective embodiment in order to block the transmission of a beam.

It is clear from FIG. 5 that the inner diameter DI in the ring stop 114 is smaller than the minimum pupil diameter DPmin at the maximum magnification of the microscope. In the present exemplary embodiment, the inner diameter DI of the ring stop is approximately 50% of the minimum pupil diameter DPmin. In other embodiment variants of the ring stop 114, the inner diameter DI may be smaller or larger than in the illustrated embodiment variant so long as it is smaller than the minimum pupil diameter DPmin. Typically, the inner diameter DI of the ring stop 114 will lie in the range of between 25 and 75% of the minimum pupil diameter DPmin.

The outer diameter DA of the ring stop 114 is smaller than the maximum pupil diameter DPmax, i.e. the pupil diameter at the minimum magnification. As may be gathered from FIG. 5, the outer diameter DA of the ring stop 114 corresponds to approximately 60% of the maximum pupil diameter DPmax in the present exemplary embodiment. However, it may also be smaller or greater than in the present exemplary embodiment. Typically, it will not correspond to more than 80% of the maximum pupil diameter DPmax. At the lower end, the outer diameter of the ring stop 114 is delimited by the minimum pupil diameter DPmin. However, the outer diameter DA will typically be greater than the minimal pupil diameter DPmin in order to bring about an increase in the depth of field not only at the maximum magnification but also at other high magnifications that do not quite reach the maximum magnification.

The effect of the ring stop 114 on beams is immediately clear from FIG. 5. At high magnifications, the stop 114 acts like a conventional depth-of-field stop as it only passes the central part of the beam 116 belonging to the small pupil and blocks the remaining parts. This effect occurs up to a certain limit magnification that is specified by the magnification at which the pupil diameter DP corresponds to the outer diameter DA of the ring stop 114. Then, at lower magnifications, i.e. larger pupil diameters DP, the part of the associated beam that lies outside of the ring stop 114 is transmitted, as shown for a beam 119 of minimum magnification, i.e. with maximum pupil diameter DPmax.

Consequently, the part of the beam 119 that lies outside of the ring stop 114 can contribute to the overall brightness of the image, and so, in the case of lower magnifications, the loss of light by the ring stop 114 has less of an effect. By contrast, in the case of magnifications above a limit magnification, the ring stop 114 acts as a true depth-of-field stop, and so there is an increase in the depth of field above the limit magnification.

In the present exemplary embodiment, in which the outer diameter DA of the ring stop 114 corresponds to approximately 60% of the maximum pupil diameter DPmax and the inner diameter DI of the ring stop 114 corresponds to approximately 17% of the maximum pupil diameter DPmax, the area shadowed by the stop 114 corresponds to πTr ·(0.60·DPmax/2)²−π(0.17 DPmax/2)² and consequently approximately 33% of the maximum pupil area π·(DPmax/2)², and so, in the case of a beam diameter corresponding to the maximum pupil diameter DPmax, approximately two thirds of the beam 119 are transmitted. Consequently, the image brightness reduces by approximately one third only in the case of minimum magnification. In comparison with a conventional depth-of-field stop, in which only the aperture defined by the inner diameter DI would transmit the beam in the case of maximum pupil diameter, this represents a significant increase in the image brightness. If only the inner diameter DI were to be taken into account for the transmission, the transmission of the beam in the case of a maximum pupil diameter would only be just under 3%, which emerges from the component of the aperture of 17% of the maximum pupil diameter DPmax.

Consequently, the described ring stop 114 facilitates an increase in the depth of field at high magnifications, and it can also be left in the beam path in the case of low magnifications without significantly reducing the image quality and image brightness.

Ideally, the ring stop 114 is arranged in a pupil plane of the microscope 2, 48. A pupil plane is situated in the plane of the aperture stop or of the optical element acting as the aperture stop or in a plane conjugate thereto. However, in the microscope, the pupil planes are often not readily accessible as they may be situated between optical elements or even within optical elements. If no pupil plane is accessible, attempts are made to arrange the ring stop 114 as close to the correct pupil plane as possible. However, away from the actual pupil plane, the pupil is displaced laterally in relation to the optical axis depending on the object field point in the observation object from which the beam penetrating the pupil emanates. Away from the pupil plane, the pupil is only centered around the optical axis for a beam that emanates from an object field point that is situated on said optical axis. In the case of object field points away from the optical axis, there is a lateral displacement of the pupil in relation to said optical axis. Therefore, if the ring stop 114 cannot be placed exactly within a pupil plane, it is advantageous if the outer diameter DA of the ring stop 114 is selected in such a way that, in the case of magnifications above a certain limit magnification, the pupil provided by the beam 116 does not project beyond the outer edge of the ring stop 114.

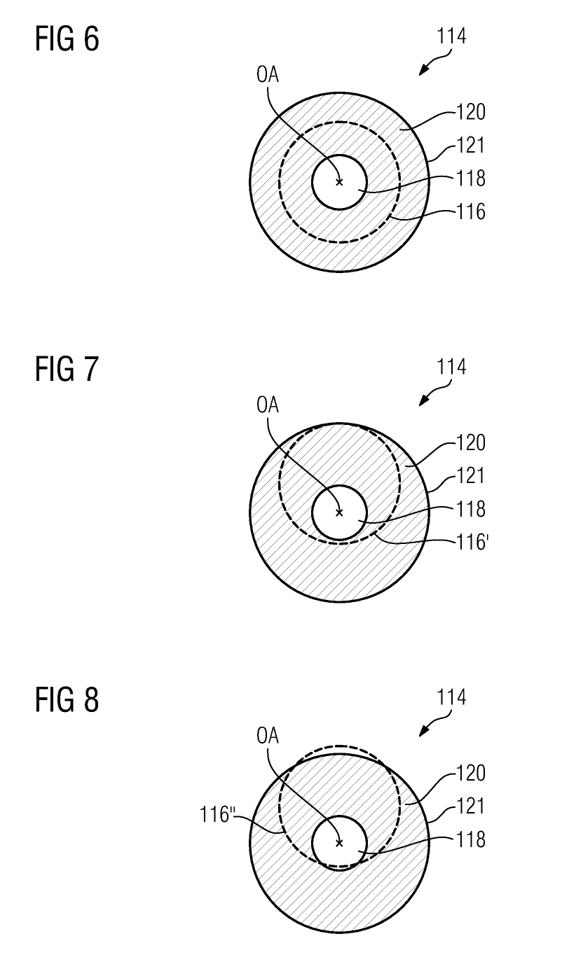

FIG. 6 shows a beam that corresponds to the limit magnification and that emanates from an object field point at the edge of the object field. The beam 116 completely covers the central aperture 118 and does not project beyond the outer edge of the opaque stop region 120. FIG. 7 shows the same beam 116 for an object field point at the edge of the object field. Consequently, what can be achieved by the suitable selection of the outer diameter DA of the stop 114 in relation to a desired limit magnification is that the desired increase in the depth of field occurs for all magnifications above the limit magnification.

Even though the outer diameter DA of the ring stop 114 is selected in such a way in FIGS. 6 and 7 that the pupil does not exceed the outer edge of the opaque stop region 120 of the ring stop 114 for all beams emanating from an object field point, it may be sufficient to select the outer diameter DA in such a way that the pupil does not project beyond the edge 121 of the opaque stop region 120 only up to a certain field radius. By contrast, for beams that emanate from object field points outside of this field radius, the pupil projects beyond the outer edge 121 of the opaque stop region 120 of the ring stop 114, as illustrated in FIG. 8. This leads to a deterioration in the depth of field, but only in the outer field region and not, however, in the central field region of the observation object. Since the region of interest often lies in the center of the field, it may be sufficient if an increased depth of field is only present in the inner region of the object field, for example in that region that lies within 50% or within 75% of the field radius. Then, regions outside of this field radius are perceived with a poorer depth of the field.

In the ring stop 114 shown in FIGS. 4 and 5, parts of the beam 119 are transmitted through the central aperture 118 and other parts of the beam 119 are transmitted outside of the outer edge 121 of the ring stop 114. The parts of the beam transmitted by the central aperture 118 on the one hand and the parts of the beam 119 transmitted outside of the edge 121 of the ring stop 114 may interfere in this case, reducing, in particular, the contrast transmission of the microscope. The cause of this is that, as a result of the interference, light from the central Airy disk is displaced into the diffraction rings, as a result of which the diffraction rings appear brighter than if the beam path were not obstructed by the stop. However, this interference can be destroyed by the insertion of an additional path in glass, either in the central aperture or in the region adjoining the outer edge 121 of the ring stop 114.

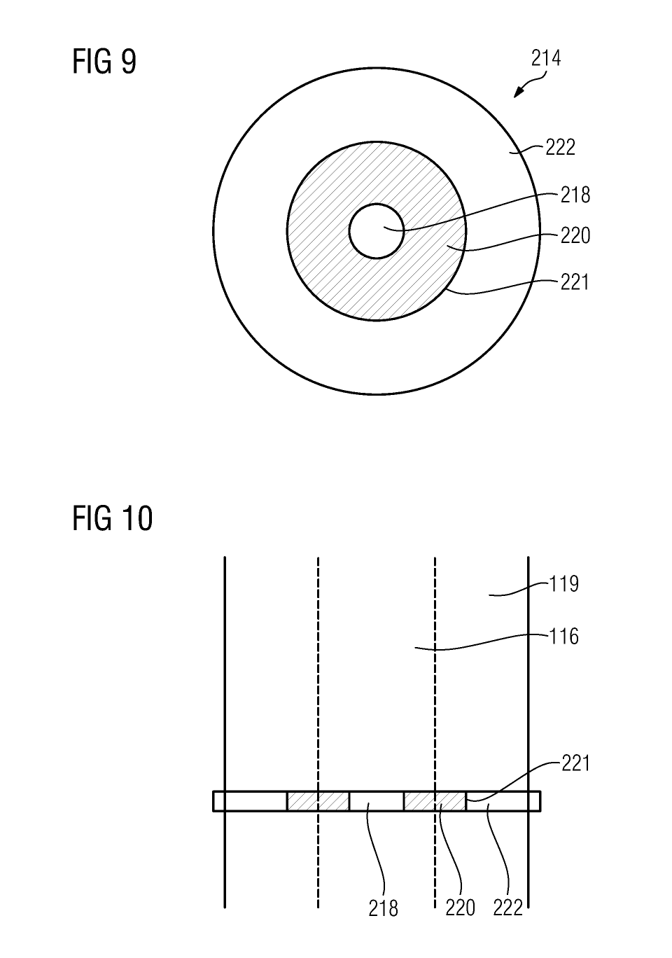

FIGS. 9 and 10 show a modification of the ring stop 114 shown in FIGS. 4 and 5. In the modified ring stop 214, the outer edge 221 of the opaque stop region 220 is adjoined by a ring-shaped glass disk 222, the glass material of which is selected in such a way that the optical path length difference between rays of the beam 119 that pass through the central stop region 218 and rays of the beam 119 that pass the glass disk 222 is greater than the coherence length of the employed light. Consequently, the glass disk 222 serves as an optical element that increases the optical path length of rays of the beam passing therethrough. On account of this increase, the interference is removed, and so no interference-induced contrast losses occur.

Instead of attaching a ring-shaped glass disk to the edge 221 of the opaque stop region 220 as illustrated in FIGS. 9 and 10, there alternatively is the option of omitting this glass disk and, instead, providing the central stop region 218 with a glass disk that increases the optical path length. The effect is the same as in the case of the ring stop 214 as described with reference to FIGS. 9 and 10.

Independently of whether a glass disk is arranged in the central aperture or at the outer edge of the opaque stop region, the goal of the glass plate is not to obtain an exact phase effect but only to destroy the coherence with the respective other region. Therefore, it is also not necessary to exactly set the thickness of the glass disk. However, thicknesses greater than 5 μm are ideal.

Even though, reference is made to a glass disk in each case in relation to the optical element for increasing the optical path length of the rays of the beam passing therethrough, it is clear to a person skilled in the art that a disk made of any other transparent material, for example a transparent polymer, can also be used instead of a glass disk.

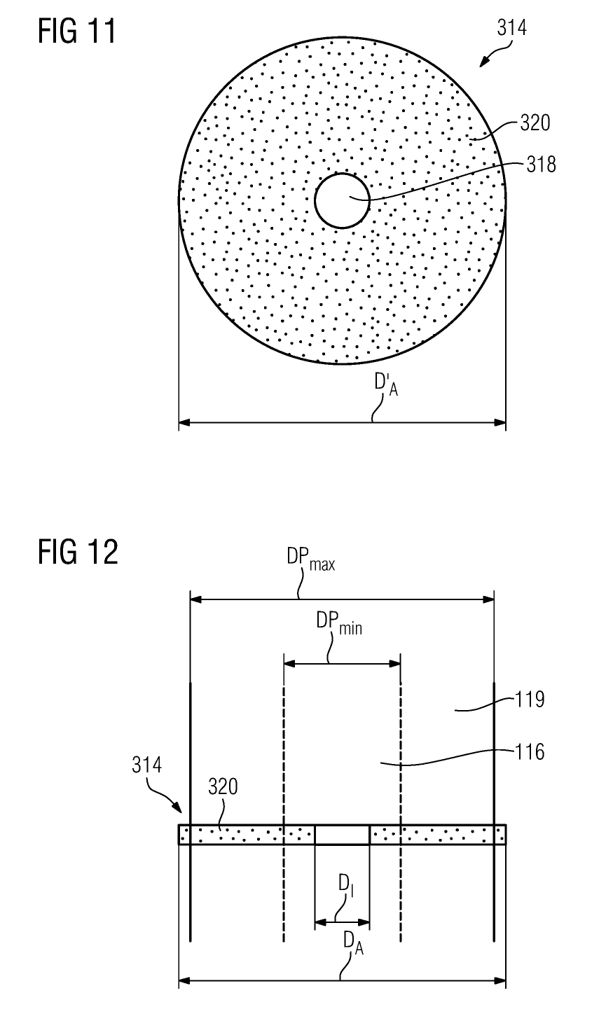

Stop apparatuses in the form of ring stops 114, 214 were described up until this point. FIGS. 11 and 12 show an alternative configuration of the stop apparatus, which is realized as a neutral-density filter 314 with the central filter aperture 318. The neutral-density filter 314 has an inner diameter DI that delimits the central filter aperture 318 and an outer diameter DA that delimits the filter to the outside. The inner diameter DI is smaller than the minimum pupil diameter and the outer diameter DA is greater than the maximum pupil diameter, as illustrated in FIG. 12. The region between the inner diameter DI and the outer diameter DA is embodied as a neutral-density filter which, in the present exemplary embodiment, has a degree of transmission of 20%.

In the case of the maximum magnification and the minimum pupil diameter DPmin accompanying this, the inner diameter DI of the neutral-density filter 314 in the present exemplary embodiment corresponds to approximately 45% of the minimum pupil diameter

DPmin. This means that the area of the central filter aperture 318 makes up approximately π·(0.45·DPmin/2)² or approximately 20% of the pupil area π·(DPmin/2)². The beam 116 defined by this minimum pupil diameter passes without an attenuation through these 20% of the pupil area. Expressed differently, 20% of the beam 116 is not attenuated during the passage through the stop apparatus. By contrast, the remaining 80% of the beam 116 provided by the minimum pupil diameter are attenuated to 20% of the intensity by the neutral-density filter. Thus, only 16% of the overall intensity of the beam 116 defined by the minimum pupil are transmitted through the neutral-density filter region 320. Overall, 20%+16%, i.e. 36%, of the overall beam 116 defined by the minimum pupil diameter are transmitted. The component of the intensity transmitted through the central filter opening 318 of the transmitted overall intensity is consequently 55%, and so the transmitted intensity is dominated by the central filter aperture, as result of which there is an increase in the depth of field. However, in comparison with the embodiment variants of the stop apparatus described with reference to FIGS. 4 to 10, a slightly lower increase in the depth of field is achieved by the stop apparatus embodied as a neutral-density filter 314.

In the case of the minimum magnification, i.e. if the maximum pupil diameter DPmax is present, the majority of the transmission of the beam 119 is effectuated by the neutral-density filter region 320. In the case of the maximum pupil diameter DPmax, the inner diameter DI of the neutral density filter corresponds to just under 20% of the pupil diameter DPmax. The area of the central filter opening 318 corresponds to π·(0.2·DPmax/2)² and consequently approximately 4% of the overall area π·(DPmax/2)² of the pupil. Only 4% of the beam 119 provided by the maximum pupil diameter DPmax are thus transmitted by the central filter opening 318. By contrast, the remaining 96% are transmitted through the neutral-density filter portion 320, to be precise with a transmission of 20%, leading to a transmission through the neutral-density filter portion 320 of approximately 19% of the intensity of the beam 119 provided by the maximum pupil diameter DPmax. The component of the intensity transmitted through the neutral-density filter portion 320 in relation to the intensity transmitted without attenuation through the central filter aperture 318 is consequently 4.8:1, and so almost five times as much intensity is transported through the neutral-density filter portion 320 than through the central filter aperture 318. The contribution of the intensity transmitted through the central filter aperture 318 in relation to the transmitted overall intensity is therefore very low, and so, in view of the resolution of the microscope, the assumption can essentially be made of the entire pupil diameter DPmax. Moreover, almost five times more light is transmitted in comparison with a conventional depth-of-field stop, and so there is a significant improvement in the image brightness in relation to a conventional depth-of-field stop.

Furthermore, in relation to the stop apparatus embodied as a ring stop according to FIGS. 4 to 10, the stop apparatus embodied as the neutral-density filter according to FIGS. 11 and 12 is advantageous in that, in the case of a migrating pupil as described in relation to FIGS. 6 to 8, the pupil is not subdivided into an inner and an outer part for any field point in the object field, and so, in the case of magnifications below the limit magnification, the impairment of the image quality is lower than in the case of the ring stop, particularly if it is configured without an optical element that destroys the coherence.

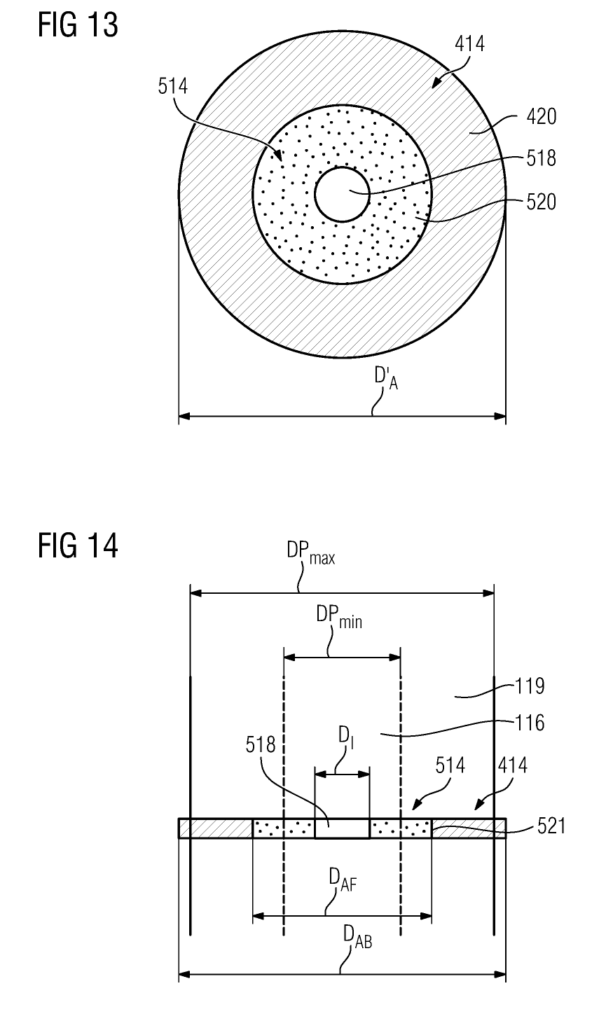

FIGS. 13 and 14 show a further embodiment variant of the stop apparatus. The embodiment variant illustrated in FIGS. 13 and 14 represents a combination of a ring stop 414 and a neutral-density filter 514. The neutral-density filter 514 substantially corresponds to the neutral-density filter as described with reference to FIGS. 11 and 12, with the difference that the outer diameter DAF of the neutral-density filter is smaller than the maximum pupil diameter DPmax and greater than the minimum pupil diameter DPmin. The outer edge 521 of the neutral-density filter 514 is adjoined by the ring stop 414 with a non-transmissive region 420, the outer diameter DAB of which is greater than the maximum pupil diameter DPmax. Its inner diameter corresponds to the outer diameter DAF of the neutral-density filter 514.

The effect of the stop apparatus illustrated in FIGS. 13 and 14 corresponds to the effect of the neutral-density filter 214 illustrated in FIG. 11 for small pupils, i.e. for high magnifications. In the case of low magnifications and the large pupils accompanying this, the non-transmissive region 420 of the outer ring stop 414 acts in an aperture-delimiting manner, and so an increase in the depth of field is also achieved at low magnifications, albeit to a smaller extent than in the case of high magnifications and the small pupil diameters accompanying this. On the other hand, an increase in the depth of field is obtained in the case of large pupil diameters without impairing the image brightness too much.

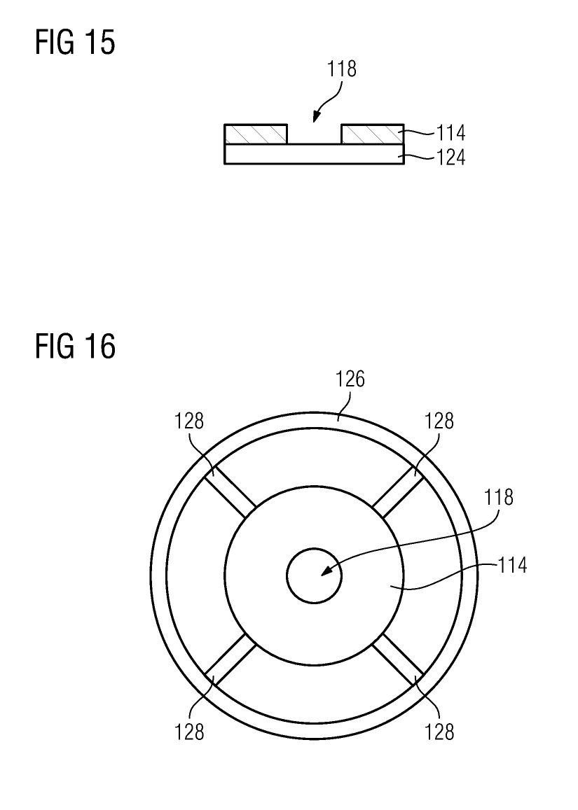

In order to be introduced into the observation beam path of the microscope, the stop apparatus can be applied onto e.g. a transparent carrier such as, for instance, a glass carrier 124 or a carrier made of any other transparent material, for instance a transparent polymer, as illustrated in FIG. 15 on the basis of a ring stop 114. By way of example, in the case of purely digital operating microscopes, use is made, as a rule, of infrared band-elimination filters that may serve as a substrate 124. If the glass carrier 124 moreover has an outer diameter that corresponds to the outer diameter of the ring stop 114, said glass carrier may moreover be embodied in such a way that it increases the optical path length of rays passing therethrough in the region of the central aperture 118 in such a way that no interference can occur with rays that pass the ring stop 114 outside of the outer edge thereof. The ring stop 114 itself can be evaporated, adhesively bonded or applied in any other way to the carrier material. It can be produced from a reflective or absorbent material, for instance metal, polymer, etc. In the case of the stop apparatus embodied as a neutral-density filter 314, the same applies in analogous fashion, except for the material applied to the carrier being partly absorbent or partly reflective.

Moreover, there is the option of designing the stop apparatus to be spectrally selective. By way of example, in the case of a ring stop 114, this can be effectuated by virtue of a material with spectral filter properties being used as a material for the ring stop 114. Then, the increase in depth of field only occurs in a certain spectral range. In the case of a neutral-density filter 214 applied to a carrier 124, there is the option, for example, of embodying the carrier 124 as a spectral filter. A possible application lies in embodying the stop apparatus as a fluorescence filter at the same time, and so the increase in depth of field only occurs in the case of fluorescence microscopy. However, in the case of a stop apparatus with a carrier 124, there also is the option of designing the carrier 124 to be transmissive for both visible light and fluorescence light and of selecting a material that is opaque or reflective for visible light but transmissive for fluorescence light as a material for a ring stop 114 that is applied onto the carrier 124. In this case, the increase in the depth of field would occur in the visible light but, in the case of fluorescence microscopy, the fluorescence light that, as a rule, is weak would be transmitted without intensity losses.

Instead of applying the ring stop 114 or the neutral-density filter 314 on a substrate 124, there also is the option of allowing the ring stop 114 or the neutral-density filter 314 to be held by a ring-shaped holder, as illustrated in FIG. 16 using the example of a ring stop 114. In addition to the ring stop 114 and the holder 126, the figure shows bridges 128, by means of which the ring stop 114 is connected to the holder 126.

The present invention has been described in detail on the basis of exemplary embodiments for explanation purposes. However, a person skilled in the art will appreciate that it is possible to depart from the described exemplary embodiments. Thus, the use of the stop apparatus in a stereoscopic microscope was described. However, in principle, the stop apparatus can also be used in a monoscopic microscope. In principle, it is also possible to provide only one of two stereoscopic partial beam paths of a stereo microscope with a stop apparatus. Likewise, there is the option, in principle, of applying a stop apparatus to each of the two partial beam paths, with the two stop apparatuses having different characteristics. Furthermore, there is the option of arranging a stop apparatus only in the branch of the beam path leading to the camera 21 in an operating microscope as illustrated in FIG. 1, whereas the branches leading to the eyepieces are not equipped with a stop apparatus, or vice versa. If different stop apparatuses are present in the partial beam paths of a stereoscopic microscope, said stop apparatuses may also be optimized for different magnifications. Thus, there is the option of providing a stop apparatus which increases the depth of field at high magnifications in one stereoscopic partial beam path and of providing a stop apparatus which increases the depth of field at low magnifications in the other stereoscopic partial beam path. Furthermore, if a neutral-density filter is used as a stop apparatus, the former can be configured in such a way that the neutral-density properties thereof can be varied. By way of example, electrochromic glass can be used to this end, the transmission of which can be influenced by varying an applied electric field. Therefore, the present invention is not intended to be restricted to the described exemplary embodiments, but rather only by the appended claims.

1. An optical observation device having a pupil and at least one adjustable low magnification and an adjustable high magnification, wherein the low magnification is linked to a large pupil diameter (DPmax) and the high magnification is linked to a small pupil diameter (DPmin), and with a stop apparatus that is arranged in a pupil plane or as close as possible to a pupil plane and that has a region diameter which delimits a central transmissive region and a partly transmissive region that surrounds the central transmissive region outside of the region diameter, wherein the region diameter (DI) is smaller than the small pupil diameter (DPmin).

2. The optical observation device as claimed in claim 1, wherein the stop apparatus is formed by a ring stop, said ring stop having an outer diameter that delimits the ring stop radially to the outside and an inner diameter that delimits the ring stop radially to the inside and forms the region diameter of the stop apparatus, wherein the inner diameter delimits a central aperture that forms the central transmissive region of the stop apparatus,
the outer diameter is at least as large as the small pupil diameter (DPmin) and smaller than the large pupil diameter (DPmax) such that the region of the ring stop situated outside of the inner diameter is geometrically partly transmissive for pupils with a pupil diameter that is greater than the outer diameter, and
the region of the ring stop situated outside of the inner diameter forms the partly transmissive region of the stop apparatus.

3. The optical observation device as claimed in claim 2, wherein the ring stop is arranged outside of a pupil plane, wherein, then, the lateral pupil position for a point in the object field with a field radius depends on the position of the point within the field radius and the outer diameter of the ring stop is selected in such a way that, for pupil diameters that are smaller than a certain limit diameter, the outer edge of the pupil does not project beyond the outer diameter of the ring stop for each position of an object point within 50% of the field radius.

4. The optical observation device as claimed in claim 2, wherein the central aperture is filled with an optical element that increases the optical path length of rays of a beam passing therethrough in such a way that the optical path length difference between rays of the beam that pass through the central aperture and rays of the beam that pass the ring stop outside of the outer diameter thereof is greater than the coherence length of the employed light.

5. The optical observation device as claimed in claim 2, wherein an optical element adjoins the outer circumference of the ring stop, said optical element increasing the optical path length of rays of a beam passing therethrough in such a way that the optical path length difference between rays of the beam that pass through the central aperture and rays of the beam that pass the optical element is greater than the coherence length of the employed light.

6. The optical observation device as claimed in claim 2, wherein the ring stop is affixed to a holder by means of braces.

7. The optical observation device as claimed in claim 1, wherein the stop apparatus is formed by a filter with a central transmissive filter region and a partly transmissive filter region that surrounds the central transmissive filter region, wherein the boundary between the central transmissive filter region and the partly transmissive filter region defines the region diameter of the stop apparatus and the central filter region forms the central transmissive region of the stop apparatus and the partly transmissive filter region forms the partly transmissive region of the stop apparatus.

8. The optical observation device as claimed in claim 7, wherein the partly transmissive filter region is formed by a neutral-density filter.

9. The optical observation device as claimed in claim 7, wherein the partly transmissive filter region has a transmission in the range from 10% to 30%.

10. The optical observation device as claimed in claim 7, wherein the transmission of the partly transmissive filter region is adjustable.

11. The optical observation device as claimed in claim 1, wherein the stop apparatus is formed by a ring stop which has an inner diameter that delimits the ring stop radially to the inside and surrounds a central stop region, wherein
the inner diameter of the ring stop is greater than the small pupil diameter (DPmin) and smaller than the large pupil diameter (DPmax),
a filter with a central transmissive filter region and a partly transmissive filter region surrounding the central transmissive filter region is present in the central stop region delimited by the inner diameter, wherein the central filter region forms the central transmissive region of the stop apparatus and the partly transmissive filter region, together with the region of the ring stop lying outside of the inner diameter, forms the partly transmissive region of the stop apparatus.

12. The optical observation device as claimed in claim 1, wherein the ring stop and/or the filter is applied onto a transmissive substrate.

13. The optical observation device as claimed in claim 1, wherein the partly transmissive region of the stop apparatus is partly transmissive for a certain wavelength range and completely transmissive for a different wavelength range.

14. The optical observation device as claimed in claim 1, wherein the stop apparatus is fastened to a holder, by means of which it can be pivoted or inserted into the beam path of the optical observation device.
